(19) United States
(12) Patent Application Publication
(10) Pub. No.: US 2019/0278163 A1
(43) Pub. Date: Sep. 12, 2019

(54) LIGHT SOURCE DEVICE AND PROJECTOR

(71) Applicant: SEIKO EPSON CORPORATION, Tokyo (JP)

(72) Inventor: Wataru YASUMATSU, AZUMINO-SHI (JP)

(73) Assignee: SEIKO EPSON CORPORATION, Tokyo (JP)

(21) Appl. No.: 16/298,248

(22) Filed: Mar. 11, 2019

(30) Foreign Application Priority Data
Mar. 12, 2018 (JP) 2018-043849

(51) Int. Cl. G03B 21/20; G02B 27/48; G02B 5/02; G03B 21/00; G03B 21/14; G03B 21/16; H04N 9/31

(52) U.S. Cl. CPC G03B 21/204; G02B 27/48; G02B 5/0284; H04N 9/3161; G03B 21/142; G03B 21/16; G03B 21/208; G03B 21/006

(57) ABSTRACT

Alight source device according to the invention includes a light source adapted to emit light, a diffuser adapted to diffusely reflect the light emitted from the light source, an optical element adapted to guide the light to the diffuser, and a first fixation member having a first space, the first fixation adapted to fix the diffuser inside the first space. The diffuser is connected to the first fixation member so as to conduct heat to each other.

### BACKGROUND

### 1. Technical Field

The present invention relates to a light source device and a projector.

### 2. Related Art

In recent years, with the view to an improvement in performance of a projector, a projector using a solid-state light source such as a laser source as a light source which is wide in color gamut and high in efficiency attracts attention. However, since the laser beam emitted from the laser source is coherent light, in the projector of this kind, a spotty pattern called speckle noise caused by interference of the laser beam is visually recognized in some cases, and thus, the display quality deteriorates. Therefore, in the projector using the solid-state light source of this kind, in order to suppress the speckle noise, there is adopted a configuration of diffusing the light emitted from the solid-state light source with a diffusion element.

For example, in JP-A-2016-184114 (Document 1), there are disclosed a light source device and a projector each provided with a light source device including a plurality of semiconductor lasers, a polarization separation device for separating the light emitted from the light source device in accordance with the polarization state, a wavelength conversion element for converting the wavelength of one of the light beams separated by the polarization separation element, and a diffusion element for diffusely reflecting the other of the light beams separated by the polarization separation element.

In the projector of Document 1, when the diffusion element is irradiated with the light emitted from the semiconductor lasers, heat is generated in the diffusion element. In the case in which, for example, the diffusion element is housed inside a fixation member, there is a problem that the heat from the diffusion element is confined inside the fixation member to thereby deteriorate the reliability of the diffusion element.

### SUMMARY

An advantage of some aspects of the invention is to provide a light source device capable of ensuring the reliability of a diffusion member to solve the problem. Another advantage of some aspects of the invention is to provide a projector equipped with the light source device described above.

Alight source device according to an aspect of the invention includes a light source adapted to emit light, a diffuser adapted to diffusely reflect the light emitted from the light source, an optical element adapted to guide the light to the diffuser, and a first fixation member having a first space, the first fixation member adapted to fix the diffuser inside the first space, and the diffuser is connected to the first fixation member so as to conduct heat to each other.

According to this configuration, since the diffuser is connected to the first fixation member so as to be able to conduct the heat to each other, rise in temperature of the diffuser is suppressed due to the conduction of the heat generated in the diffuser to the first fixation member. Thus, the reliability of the diffuser can be ensured.

In the light source device according to the aspect of the invention, the diffuser may include a diffusion element and a radiation member connected to the diffusion element to radiate heat from the diffusion element, and at least a part of the radiation member may be disposed outside the first fixation member.

According to this configuration, the heat generated in the diffusion element is conducted to the first fixation member, and in addition, discharged outside the first fixation member via the radiation member. Thus, the reliability of the diffusion element can be ensured.

The light source device according to the aspect of the invention may further include a wavelength diffuser adapted to convert wavelength of the light emitted from the light source, and the first fixation member may fix the light source and the wavelength converter inside the first space.

According to this configuration, it is possible to obtain light different in wavelength from the light emitted from the light source due to the wavelength converter. Further, since the light source and the wavelength converter are also fixed to the first fixation member in addition to the diffusion element and the optical element, there is no chance for the number of the fixation members, and thus, it is possible to achieve reduction in size of the light source device.

The light source device according to the aspect of the invention may further include a wavelength converter adapted to convert wavelength of the light emitted from the light source, and a second fixation member having a second space, the second fixation member adapted to fix the light source and the wavelength converter inside the second space, and the second fixation member may be a separate body from the first fixation member.

According to this configuration, it is possible to obtain light different in wavelength from the light emitted from the light source due to the wavelength converter. Further, since the second fixation member to which the wavelength converter is fixed and the first fixation member to which the diffuser is fixed are separated from each other, it is difficult for the heat generated in the light source and the wavelength converter to affect the diffuser.

In the light source device according to an aspect of the invention, the second fixation member may be connected to the first fixation member via a thermal insulation material.

According to this configuration, it is difficult for the heat generated in the light source and the wavelength converter to affect the diffuser. Further, it is easy to treat the first fixation member and the second fixation member in a lump.

The light source device according to the aspect of the invention may further include a holding member adapted to hold the optical element, and a light reflecting side of the diffuser may be covered with both the optical element and the holding member.

According to this configuration, since the light emitted with a large divergence angle out of the light diffusely reflected by the diffuser is blocked by the holding member, it is possible to prevent the stray light from being generated in the first space.

The light source device according to the aspect of the invention may further include a retardation element adapted to convert a polarization state of light, the first fixation member may have an opening through which light proceeding toward the diffuser and light diffusely reflected by the diffuser pass, and the opening may be closed by the retardation element.

According to this configuration, the retardation element makes the polarization state of the light diffusely reflected by the diffuser different from the polarization state of the light proceeding toward the diffuser. Thus, it is possible to adopt, for example, a configuration of combining the light having diffusely been reflected by the diffuser and other light with each other by the polarization combining element, and thus, it is possible to ensure the reliability of the diffuser. Further, it is not necessary to separately prepare a member for closing the opening of the first fixation member.

A projector according to another aspect of the invention includes the light source device according to any one of the aspects of the invention, a light modulation device adapted to modulate the light from the light source device in accordance with image information, and a projection optical device adapted to project the light modulated by the light modulation device.

According to this configuration, it is possible to obtain a projector excellent in reliability.

### BRIEF DESCRIPTION OF THE DRAWINGS

The invention will be described with reference to the accompanying drawings, wherein like numbers reference like elements.

FIG. 1 is a schematic configuration diagram of a projector according to a first embodiment of the invention.

FIG. 2 is a schematic configuration diagram of a light source device according to the first embodiment.

FIG. 3 is a perspective view of the light source device.

FIG. 4 is a cross-sectional view of a diffusion section.

FIG. 5 is a cross-sectional view of a diffusion section of a first modified example.

FIG. 6 is a cross-sectional view of a diffusion section of a second modified example.

FIG. 7 is a cross-sectional view of a diffusion section of a third modified example.

FIG. 8 is a schematic configuration diagram of a light source device according to a second embodiment.

FIG. 9 is a schematic configuration diagram of a light source device according to a third embodiment.

FIG. 10 is a schematic configuration diagram of a light source device according to a fourth embodiment.

FIG. 11 is a schematic configuration diagram of a light source device according to a fifth embodiment.

FIG. 12 is a graph showing a relationship between an EP value and speckle contrast.

FIG. 13 is a diagram for explaining the speckle contrast.

FIG. 14 is a diagram showing coordinate axes of an illuminance distribution in a calculation formula of the EP value.

### DESCRIPTION OF EXEMPLARY EMBODIMENTS

### First Embodiment

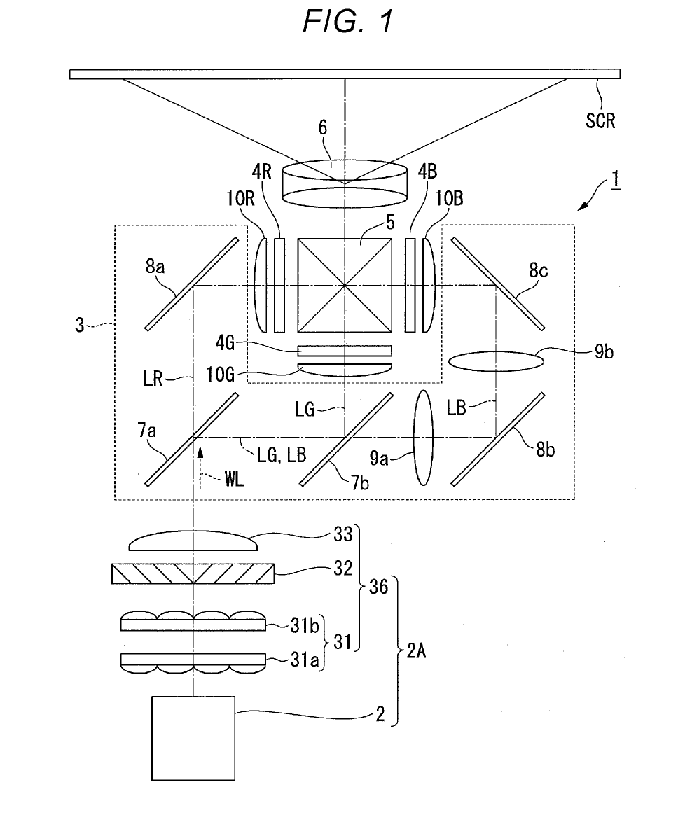

Hereinafter, a first embodiment of the invention will be described using FIG. 1 through FIG. 7.

FIG. 1 is a schematic configuration diagram of the projector according to the present embodiment.

It should be noted that in each the following drawings, the constituents are shown with the scale ratios of respective sizes set differently between the constituents in some cases in order to facilitate the visualization of each of the constituents.

Projector

As shown in FIG. 1, the projector 1 according to the present embodiment is a projection-type image display device for displaying a color picture (image) on a screen (projection target surface) SCR. The projector 1 uses three light modulation devices corresponding respectively to colored light beams, namely a red light beam LR, a green light beam LG, and a blue light beam LB. The projector 1 uses semiconductor lasers (laser sources), with which high-intensity and high-power light can be obtained, as a light source of an illumination device.

The projector 1 is provided with an illumination device 2A, a color separation optical system 3, a light modulation device 4R, a light modulation device 4G, a light modulation device 4B, a combining optical system 5, and a projection optical device 6.

The illumination device 2A emits illumination light WL toward the color separation optical system 3. The illumination device 2A is provided with a light source device 2 and a homogenous illumination optical system 36.

The homogenous illumination optical system 36 is provided with an integrator optical system 31, a polarization conversion element 32, and a superimposing optical system 33. It should be noted that the polarization conversion element 32 is not an essential element. The homogenous illumination optical system 36 homogenizes the intensity distribution of the illumination light WL emitted from the light source device 2 in an illumination target area.

The integrator optical system 31 is provided with a lens array 31a and a lens array 31b. The lens array 31a and the lens array 31b each have a configuration having a plurality of lenses arranged in an array.

The illumination light WL having passed through the integrator optical system 31 enters the polarization conversion element 32. The polarization conversion element 32 is provided with a polarization separation film (not shown), a wave plate (not shown) and a reflecting mirror (not shown). The polarization conversion element 32 converts the illumination light WL into linearly-polarized light having a predetermined polarization direction.

The illumination light WL having passed through the polarization conversion element 32 enters the superimposing optical system 33. The superimposing optical system 33 is formed of a convex lens. The superimposing optical system 33 superimposes the illumination light WL having been emitted from the polarization conversion element 32 in the illumination target area. In the present embodiment, the illuminance distribution in the illumination target area is homogenized by the integrator optical system 31 and the superimposing optical system 33.

The illumination light WL having been emitted from the homogenous illumination optical system 36 enters the color separation optical system 3. The color separation optical system 3 separates the illumination light WL into the red light beam LR, the green light beam LG and the blue light beam LB. The color separation optical system 3 is provided with a first dichroic mirror 7a, a second dichroic mirror 7b, a first total reflection mirror 8a, a second total reflection mirror 8b, a third total reflection mirror 8c, a first relay lens 9a and a second relay lens 9b.

The first dichroic mirror 7a separates the illumination light WL from the light source device 2 into the red light beam LR and the other light beams (the green light beam LG and the blue light beam LB). The first dichroic mirror 7a transmits the red light beam LR, and at the same time reflects the other light beams (the green light beam LG and the blue light beam LB). Meanwhile, the second dichroic mirror 7b separates the light beams having been reflected by the first dichroic mirror 7a into the green light beam LG and the blue light beam LB. The second dichroic mirror 7b reflects the green light beam LG, and at the same time, transmits the blue light beam LB.

The first total reflection mirror 8a reflects the red light beam LR, which has been transmitted through the first dichroic mirror 7a, toward the light modulation device 4R. The second total reflection mirror 8b and the third total reflection mirror 8c reflect the blue light beam LB, which has been transmitted through the second dichroic mirror 7b, toward the light modulation device 4B. The second dichroic mirror 7b reflects the green light beam LG toward the light modulation device 4G.

The first relay lens 9a and the second relay lens 9b are disposed on the light emission side of the second dichroic mirror 7b in the light path of the blue light beam LB.

The light modulation device 4R modulates the red light beam LR in accordance with image information to form a red image light beam. The light modulation device 4G modulates the green light beam LG in accordance with the image information to form a green image light beam. The light modulation device 4B modulates the blue light beam LB in accordance with the image information to form a blue image light beam.

As each of the light modulation device 4R, the light modulation device 4G and the light modulation device 4B, there is used a transmissive liquid crystal panel. Further, on the incident side and the exit side of each of the liquid crystal panels, there are respectively disposed polarization plates (not shown).

On the incident side of the light modulation device 4R, the light modulation device 4G and the light modulation device 4B, there are disposed a field lens 10R, a field lens 10G and a field lens 10B, respectively.

The combining optical system 5 combines the image light beams respectively emitted from the light modulation device 4R, the light modulation device 4G and the light modulation device 4B with each other to emit the result toward the projection optical device 6. As the combining optical system 5, there is used a cross dichroic prism.

The projection optical device 6 is provided with a projection lens group including a plurality of projection lenses. The projection optical device 6 projects the image light having been combined by the combining optical system 5 toward the screen SCR in an enlarged manner. In other words, the projection optical device 6 projects the light beams having respectively been modulated by the light modulation device 4R, the light modulation device 4G and the light modulation device 4B.

### Light Source Device

Then, the light source device 2 of the present embodiment will be described.

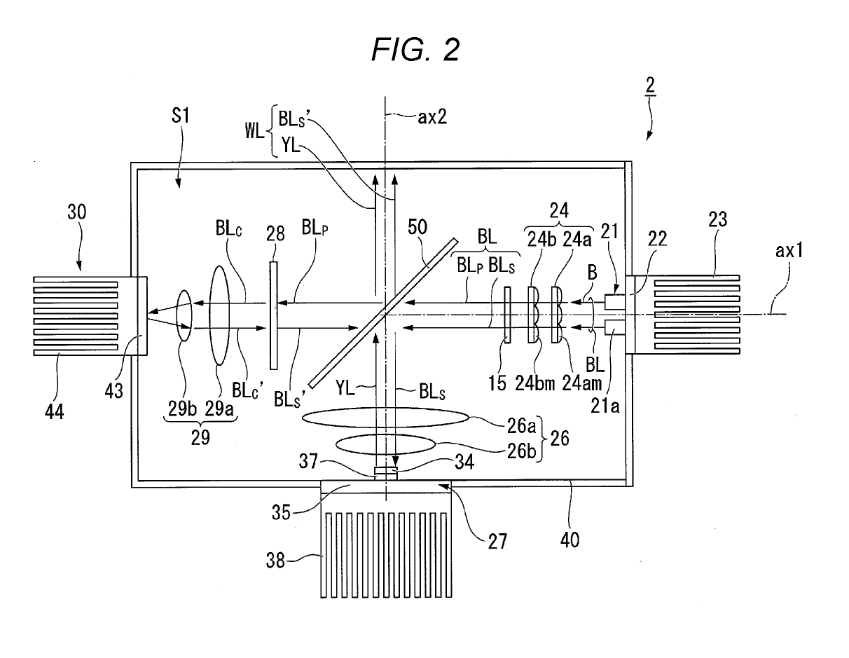

FIG. 2 is a schematic configuration diagram of the light source device 2.

As shown in FIG. 2, the light source device 2 is provided with a first fixation member 40, a light source 21, a homogenizer optical system 24, a first wave plate 15, a polarization separation element 50, a first light collection optical system 26, a wavelength conversion section (a wavelength converter) 27, a second wave plate 28 (retardation element), a second light collection optical system 29 (optical element), and a diffusion section (a diffuser) 30.

The light source 21, the homogenizer 24, the first wave plate 15, the polarization separation element 50, the second wave plate 28, the second light collection optical system 29 and the diffusion section 30 are arranged in series on an optical axis ax1. Further, the wavelength conversion section 27, the first light collection optical system 26, and the polarization separation element 50 are arranged in series on an optical axis ax2. The optical axis ax1 and the optical axis ax2 are located in the same plane, and are perpendicular to each other.

The light source 21 is provided with a plurality of semiconductor lasers 21a, a support substrate 22 and a first heatsink 23. The plurality of semiconductor lasers 21a is arranged in an array in a surface of the support substrate 22 perpendicular to the optical axis ax1. The number of the semiconductor lasers 21a is not particularly limited. Alternatively, the light source 21 can be provided with a single semiconductor laser 21a. The semiconductor lasers 21a emit blue light beams B with a peak wavelength of, for example, 460 nm as excitation light beams. The light beams B emitted from the semiconductor lasers 21a are emitted in the state of being converted by a collimator lens (not shown) into parallel light. Therefore, the light source 21 emits a pencil BL formed of the plurality of blue light beams B.

The pencil BL enters the homogenizer optical system 24. The homogenizer optical system 24 is provided with a first lens array 24a and a second lens array 24b. The first lens array 24a is provided with a plurality of first lenses 24am arranged in an array. The second lens array 24b is provided with a plurality of second lenses 24bm arranged in an array.

The pencil BL having passed through the homogenizer optical system 24 enters the first wave plate 15. The first wave plate 15 is formed of a quarter-wave plate made to be able to rotate around a rotational axis parallel to the optical axis ax1. Since the light beam B emitted from the semiconductor laser 21a is linearly-polarized light, by appropriately setting the angle of the optical axis of the quarter-wave plate with respect to the polarization direction of the linearly-polarized light, the linearly-polarized light having entered the first wave plate 15 can be converted into light including an S-polarization component BLs and a P-polarization component BLp with respect to the polarization separation element 50 in a predetermined proportion. Therefore, by rotating the first wave plate 15, it is possible to change the ratio between the S-polarization component BLs and the P-polarization component BLp.

The polarization separation element 50 is formed of a dichroic mirror having wavelength selectivity. The polarization separation element 50 is disposed so as to form an angle of 45° with respect to each of the optical axis ax1 and the optical axis ax2. The polarization separation element 50 separates the pencil BL having passed through the first wave plate 15 into the S-polarization component BLs and the P-polarization component BLp with respect to the polarization separation element 50. The S-polarization component BLs is reflected by the polarization separation element 50, and then proceeds toward the wavelength conversion section 27. The P-polarization component BLp is transmitted through the polarization separation element 50, and then proceeds toward the diffusion section 30. Hereinafter, the S-polarization component BLs is referred to as a pencil BLs, and the P-polarization component BLp is referred to as a pencil BLp.

The polarization separation element 50 transmits fluorescent light YL different in wavelength band from the pencil BL regardless of the polarization state of the fluorescent light YL. Thus, the polarization separation element 50 has a light combining function for combining the reflected light emitted from the diffusion section 30 and the fluorescent light YL emitted from the wavelength conversion section 27 with each other.

The pencil BLs having been reflected by the polarization separation element 50 enters the first light collection optical system 26. The first light collection optical system 26 converges the pencil BLs toward a phosphor layer 34 of the wavelength conversion element 27. The first light collection optical system 26 homogenizes the illuminance distribution by the pencil BLs on the phosphor layer 34 in cooperation with the homogenizer optical system 24. The first light collection optical system 26 is provided with a pickup lens 26a and a pickup lens 26b.

The pencil BLs having been emitted from the first light collection optical system 26 enters the wavelength conversion section 27. The wavelength conversion section 27 is provided with the phosphor layer 34, a substrate 35, a reflecting layer 37 and a second heatsink 38, and converts the wavelength of the incident light. The substrate 35 supports the phosphor layer 34. The reflecting layer 37 is disposed between the phosphor layer 34 and the substrate 35. The wavelength conversion section 27 is fixed to the first fixation member 40 so that the phosphor layer 34 is opposed to the first light collection optical system 26. The phosphor layer 34 is disposed at the focal position of the first light collection optical system 26.

The phosphor layer 34 includes phosphor particles for absorbing the pencil BLs as the excitation light to convert the pencil BLs into the yellow fluorescent light YL, and then emitting the yellow fluorescent light YL. As the phosphor particles, there can be used, for example, yttrium aluminum garnet (YAG) based phosphor. As the phosphor layer 34, a phosphor layer obtained by dispersing the phosphor particles in an inorganic binder such as alumina, or a phosphor layer obtained by sintering the phosphor particles without using the binder can preferably be used.

A part of the fluorescent light YL converted by the phosphor layer 34 is reflected by the reflecting layer 37, and is then emitted to the outside of the phosphor layer 34. In such a manner, the fluorescent light YL is efficiently emitted from the phosphor layer 34 toward the first light collection optical system 26. The fluorescent light YL having been emitted from the phosphor layer 34 is transmitted through the first light collection optical system 26 and the polarization separation element 50.

Meanwhile, the pencil BLp having been transmitted through the polarization separation element 50 enters the second wave plate 28. The second wave plate 28 is formed of a quarter-wave plate, and converts the polarization state of the incident light. The pencil BLp as the P-polarized light is transmitted through the second wave plate 28 to thereby be converted into a pencil BLc as circularly-polarized light, and then enters the second light collection optical system 29.

The second light collection optical system 29 guides the pencil BLc to the diffusion section 30 in a converged state. The second light collection optical system 29 is provided with a pickup lens 29a and a pickup lens 29b. The second light collection optical system 29 homogenizes the illuminance distribution by the pencil BLc in the diffusion section 30 in cooperation with the homogenizer optical system 24. The pickup lens 29a and the pickup lens 29b are fixed to the first fixation member 40.

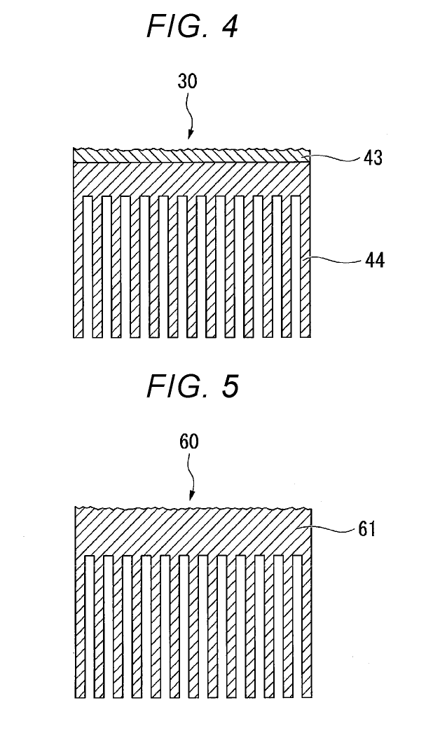

FIG. 4 is a cross-sectional view of the diffusion section 30.

As shown in FIG. 4, the diffusion section 30 is provided with a diffusion plate 43 (a diffusion element) and a third heatsink 44 (a radiation member). The diffusion plate 43 is formed of a metal material high in optical reflectance such as aluminum. The diffusion plate 43 can be manufactured by performing a blast treatment on, for example, one surface of an aluminum substrate to thereby form a rough surface structure all over the surface. It is also possible to form at least one of a silver film and a dielectric multilayer film on the surface of the diffusion plate 43 provided with the rough surface structure. The diffusion plate 43 and the third heatsink 44 are bonded to each other with an adhesive.

Hereinafter, the light reflected by the diffusion section 30 is referred to as a pencil BLc′. It is preferable for the diffusion section 30 to have a property of causing Lambertian reflection of the pencil BLc having entered the diffusion section 30. The diffusion section 30 diffusely reflects the pencil BLc, which has been emitted from the second light collection optical system 29, toward the polarization separation element 50.

As shown in FIG. 2, the pencil BLc′ (diffused light) as the circularly-polarized light reflected by the diffusion section 30 and then transmitted again through the second light collection optical system 29 is transmitted again through the second wave plate 28 to turn to a pencil BLs' as the S-polarized light. The pencil BLs' as blue light and the fluorescent light YL as yellow light are combined with each other by the polarization separation element 50 to turn to the illumination light WL as white light. The illumination light WL enters the homogenous illumination optical system 36 shown in FIG. 1.

The first heatsink 23 is connected to the support substrate 22 of the light source 21, and radiates the heat generated in the light source 21 to the outside of the first fixation member 40. The second heatsink 38 is connected to the substrate 35 of the wavelength conversion section 27, and radiates the heat generated in the wavelength conversion section 27 to the outside of the first fixation member 40. The third heatsink 44 is connected to the diffusion plate 43, and radiates the heat generated in the diffusion plate 43 to the outside of the first fixation member 40.

Hereinafter, a configuration of the first fixation member 40 will be described.

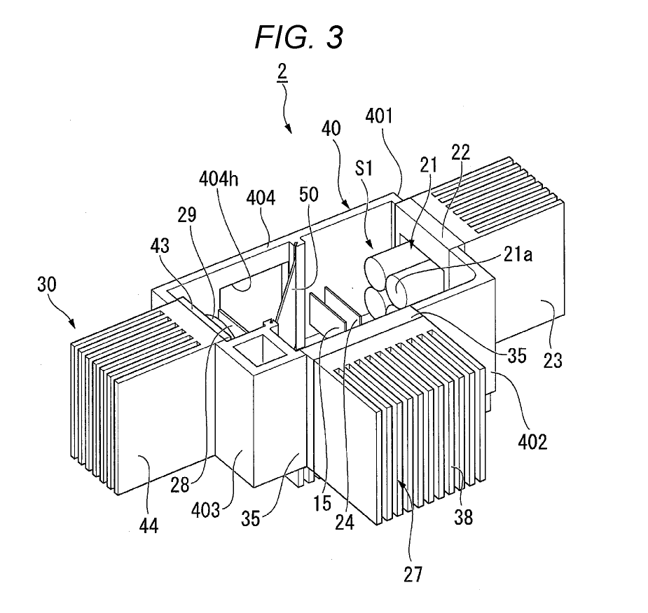

FIG. 3 is a perspective view showing the first fixation member 40 and constituent members on the periphery of the first fixation member 40. In FIG. 3, in order to make the drawings eye-friendly, illustration of an upper plate part of the first fixation member 40 is omitted.

As shown in FIG. 3, the first fixation member 40 is a box-like member formed of metal high in thermal conductivity such as copper or aluminum. The first fixation member 40 is provided with a first side plate part 401, a second side plate part 402, a third side plate part 403, a fourth side plate part 404, a bottom plate part and the upper plate part (not shown), and has a first space S1 surrounded by these plate parts.

In the first space S1, there are housed the light source 21, the homogenizer optical system 24, the first wave plate 15, the polarization separation element 50, the first light collection optical system 26 (see FIG. 2), the wavelength conversion section 27, the second wave plate 28, the second light collection optical system 29 and the diffusion section 30. Further, the first fixation member 40 fixes the light source 21, the homogenizer optical system 24, the first wave plate 15, the polarization separation element 50, the first light collection optical system 26 (see FIG. 2), the wavelength conversion section 27, the second wave plate 28, the second light collection optical system 29 and the diffusion section 30 inside the first space S1.

The light source 21 is fixed to the first side plate part 401. The wavelength conversion section 27 is fixed to the second side plate part 402. The diffusion section 30 is fixed to the third side plate part 403. In the fourth side plate part 404, there is disposed an opening 404h for transmitting the illumination light WL.

The diffusion section 30 is connected to the first fixation member 40 so as to be able to conduct heat to each other. In the case of the present embodiment, the third heatsink 44 constituting the diffusion section 30 is connected to the third side plate part 403 of the first fixation member 40 so as to be able to conduct heat to each other. It should be noted that it is also possible to adopt a configuration in which the diffusion plate 43 is connected to the first fixation member 40 (the third side plate part 403) so as to be able to conduct heat to each other instead of the configuration described above.

In the present embodiment, the third heatsink 44 constituting the diffusion section 30 is not housed inside the first space S1, and a part other than a part connected to the first fixation member 40 of the third heatsink 44 is disposed outside the first fixation member 40. In other words, at least a part of the third heatsink 44 is disposed outside the first fixation member 40. It should be noted that in the case in which the diffusion plate 43 is connected to the first fixation member 40 as described above, the whole of the third heatsink 44 is disposed outside the first fixation member 40. In still other words, the third heatsink 44 projects outside the first fixation member 40. The third heatsink 44 is formed of metal high in thermal conductivity such as copper or aluminum, and has a plurality of fins.

In the present specification, in the case in which the diffusion section is constituted by a plurality of constituents such as the diffusion plate and the heatsink, and the constituents are connected to each other so as to be able to conduct heat to each other, the expression that “the diffusion section is connected to the first fixation member so as to be able to conduct heat to each other” means a configuration in which at least one of the constituents is directly connected to the first fixation member, or a configuration in which at least one of the constituents is connected to the first fixation member via another member (e.g., a metallic member) having thermal conductivity. In contrast, a configuration in which, for example, the constituent to be connected to the first fixation member out of the plurality of constituents is connected via a thermal insulation material does not correspond to the expression that “the diffusion section is connected to the first fixation member so as to be able to conduct heat to each other.”

In the light source device 2 according to the present embodiment, since the diffusion section 30 is connected to the first fixation member 40 so as to be able to conduct heat to each other, the heat generated in the diffusion section 30 is efficiently conducted to the first fixation member 40, and thus, rise in temperature of the diffusion section 30 is suppressed. Thus, the reliability of the diffusion section 30 can be ensured. In particular, since the diffusion plate 43 is directly connected to the third heatsink 44, and the third heatsink 44 is disposed outside the first fixation member 40, the heat generated in the diffusion plate 43 is conducted to the first fixation member 40 via the third heatsink 44, and at the same time, radiated outside the first fixation member 40. Thus, the reliability of the diffusion plate 43 can be ensured.

Further, in the light source device 2 according to the present embodiment, since the light source 21 and the wavelength conversion section 27 are also fixed to the first fixation member 40 in addition to the diffusion section 30 and the second light collection optical system 29, the heat generated in the light source 21 and the wavelength conversion section 27 is efficiently conducted to the first fixation member 40, and thus, rise in temperature of the light source 21 and the wavelength conversion section 27 is suppressed. Thus, it is also possible to ensure the reliability of the light source 21 and the wavelength conversion section 27. Further, according to this configuration, the number of the fixation members does not increase, and thus, reduction in size of the light source device 2 can be achieved.

Further, in the light source device 2 according to the present embodiment, since the first fixation member 40 also fixes the light source 21 and the wavelength conversion section 27 in addition to the diffusion section 30 and the second light collection optical system 29 as described above, by radiating the heat generated in the diffusion plate 43 in the diffusion section 30 outside the first fixation member 40 via the third heatsink 44, it is possible to prevent the heat in the diffusion plate 43 from being confined inside the first space S1 to raise the temperature of the light source 21 and the phosphor layer 34.

As described above, according to the present embodiment, it is possible to provide the light source device 2 small in size and capable of efficiently cooling the diffusion section 30. Therefore, the projector 1 according to the present embodiment including the light source device 2 is high in reliability.

The configuration of the diffusion section 30 is not limited to the configuration described above, but a variety of modified examples described below can be adopted.

### First Modified Example

FIG. 5 is a cross-sectional view of a diffusion section 60 of a first modified example.

As shown in FIG. 5, the optical element 60 of the first modified example is provided with a diffusion element 61 having a diffusion plate and the third heatsink integrated with each other. The diffusion element 61 can be manufactured by performing a blast treatment on one surface of the third heatsink made of, for example, aluminum to thereby forma rough surface structure all over the surface.

### Second Modified Example

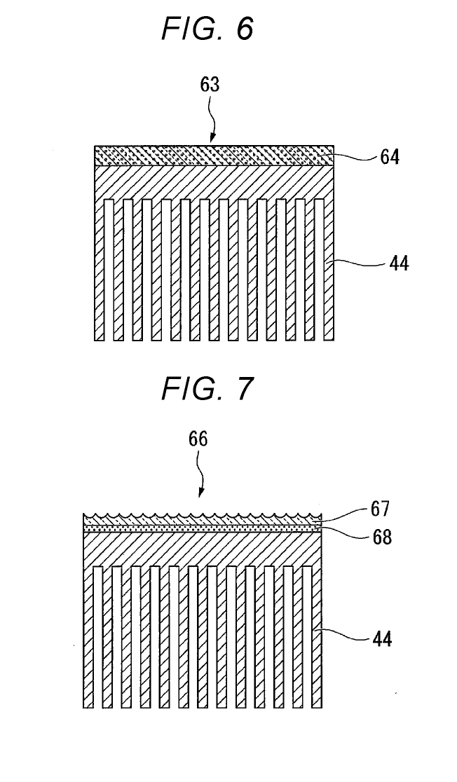

FIG. 6 is a cross-sectional view of a diffusion section 63 of a second modified example.

As shown in FIG. 6, the diffusion section 63 of the second modified example is provided with a diffusion plate 64, and the third heatsink 44. The diffusion plate 64 is formed of a so-called volume-scattering diffusion plate which is a diffusion plate obtained by dispersing a plurality of scattering particles having a different refractive index from the refractive index of a base material inside the base material having a light transmissive property such as glass. The diffusion plate 64 and the third heatsink 44 are bonded to each other with an adhesive.

### Third Modified Example

FIG. 7 is a cross-sectional view of a diffusion section 66 of a third modified example.

As shown in FIG. 7, the diffusion section 66 of the third modified example is provided with a diffusion plate 67, a reflecting layer 68 and the third heatsink 44. The diffusion plate 67 is formed of a diffusion plate obtained by forming a rough surface structure on a surface of a base material having a light transmissive property such as glass. The reflecting layer 68 is disposed between the diffusion plate 67 and the third heatsink 44. It should be noted that the reflecting layer 68 can be disposed on the surface on the side provided with the rough surface structure of the diffusion plate 67.

### Second Embodiment

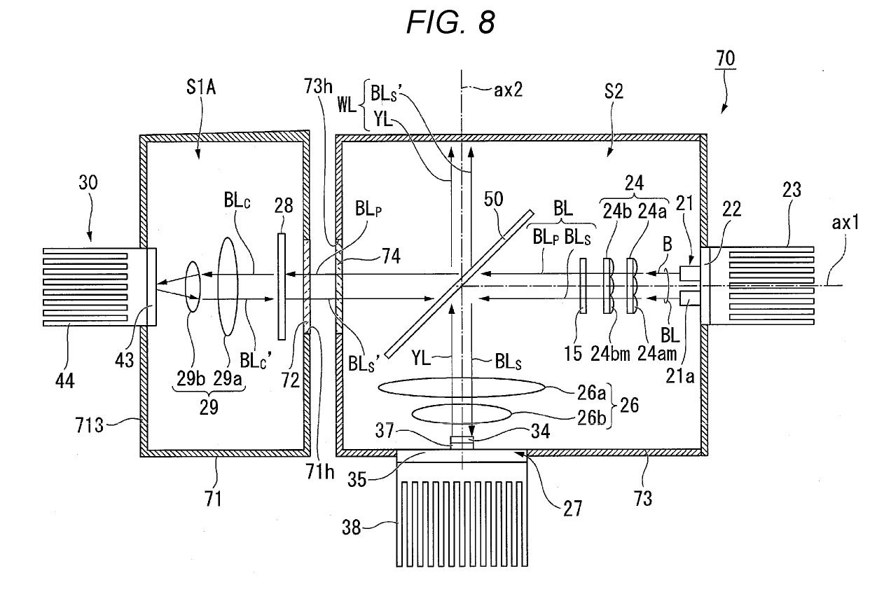

Hereinafter, a second embodiment of the invention will be described using FIG. 8.

A projector according to the second embodiment is roughly the same in basic configuration as that of the first embodiment, but is different in the configuration of the light source device from that of the first embodiment. Therefore, the description of the projector will be omitted, and only the light source device will be described.

FIG. 8 is a schematic configuration diagram of the light source device 70 according to the second embodiment.

In FIG. 8, the constituents common to the drawings used in the first embodiment are denoted by the same reference symbols, and the detailed description thereof will be omitted.

As shown in FIG. 8, the light source device 70 according to the present embodiment is provided with a first fixation member 71, a first window member 72, a second fixation member 73, a second window member 74, the light source 21, the homogenizer optical system 24, the first wave plate 15, the polarization separation element 50, the first light collection optical system 26, the wavelength conversion section 27, the second wave plate 28, the second light collection optical system 29 (the optical element), and the diffusion section 30. The second fixation member 73 is configured as a separate member from the first fixation member 71.

The first fixation member 71 is a box-like member formed of metal high in thermal conductivity such as copper or aluminum, and has a first space S1A surrounded by a plurality of plate parts. In the first space S1A, there are housed the second wave plate 28, the second light collection optical system 29 and the diffusion section 30. Further, the first fixation member 71 fixes the second wave plate 28, the second light collection optical system 29 and the diffusion section 30 inside the first space S1A.

The first fixation member 71 has an opening 71h which the light proceeding from the polarization separation element 50 toward the diffusion section 30, and the light diffusely reflected by the diffusion section 30 pass through. The opening 71h is closed by the first window member 72. The first window member 72 is formed of a base material having a light transmissive property such as glass. According to this configuration, the first space S1A becomes a closed space, and there is no chance for dust or the like to enter the first space S1A.

Similarly to the first fixation member 71, the second fixation member 73 is a box-like member formed of metal high in thermal conductivity such as copper or aluminum, and has a second space S2 surrounded by a plurality of plate parts. In the second space S2, there are housed the light source 21, the homogenizer optical system 24, the first wave plate 15, the polarization separation element 50, the first light collection optical system 26 and the wavelength conversion section 27. Further, the second fixation member 73 fixes the light source 21, the homogenizer optical system 24, the first wave plate 15, the polarization separation element 50, the first light collection optical system 26 and the wavelength conversion section 27 inside the second space S2.

The second fixation member 73 has an opening 73h which the light proceeding from the polarization separation element 50 toward the diffusion section 30, and the light diffusely reflected by the diffusion section 30 pass through. The opening 73h is closed by the second window member 74. The second window member 74 is formed of a base material having alight transmissive property such as glass. According to this configuration, the second space S2 becomes a closed space, and there is no chance for dust or the like to enter the second space S2.

The diffusion section 30 is connected to the first fixation member 71 so as to be able to conduct heat to each other. In the case of the present embodiment, the third heatsink 44 constituting the diffusion section 30 is connected to a third side plate part 713 of the first fixation member 71 so as to be able to conduct heat to each other. It should be noted that it is also possible to adopt a configuration in which the diffusion plate 43 constituting the diffusion section 30 is connected to the first fixation member 71 so as to be able to conduct heat to each other instead of the configuration described above.

At least a part of the third heatsink 44 constituting the diffusion section 30 is disposed outside the first fixation member 71. The third heatsink 44 is formed of metal high in thermal conductivity such as copper or aluminum, and has a plurality of fins.

The rest of the configuration is substantially the same as that of the first embodiment.

Also in the light source device 70 according to the present embodiment, since the diffusion section 30 is connected to the first fixation member 71 so as to be able to conduct heat to each other, it is possible to obtain substantially the same advantage as that of the first embodiment, namely the advantage that the heat generated in the diffusion section 30 is efficiently conducted to the first fixation member 71, and thus, the reliability of the diffusion section 30 can be ensured.

Further, in the present embodiment, since the wavelength conversion section 27 and the light source 21 are fixed to the second fixation member 73, and at the same time, the second fixation member 73 is a separate member from the first fixation member 71, it is hard for the heat generated in the wavelength conversion section 27 and the light source 21 to affect the diffusion section 30.

### Third Embodiment

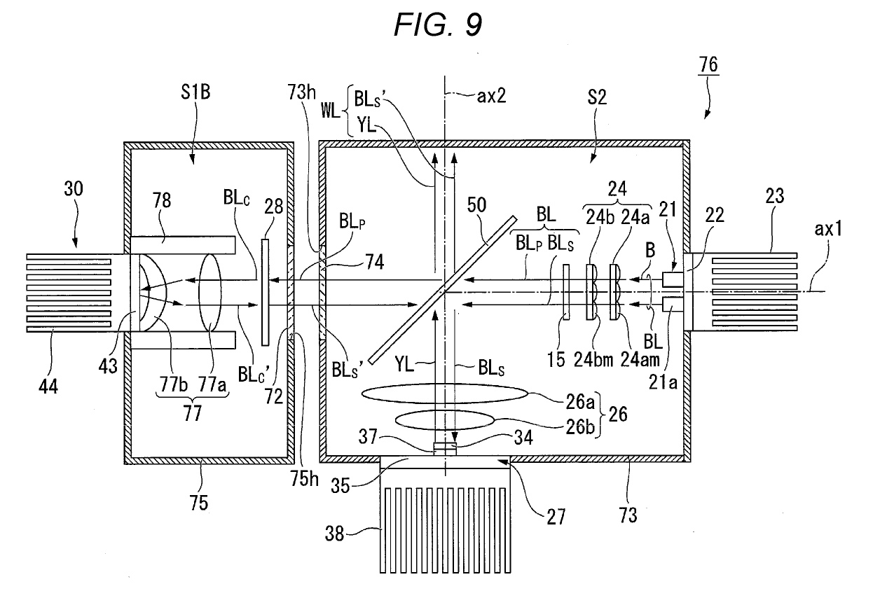

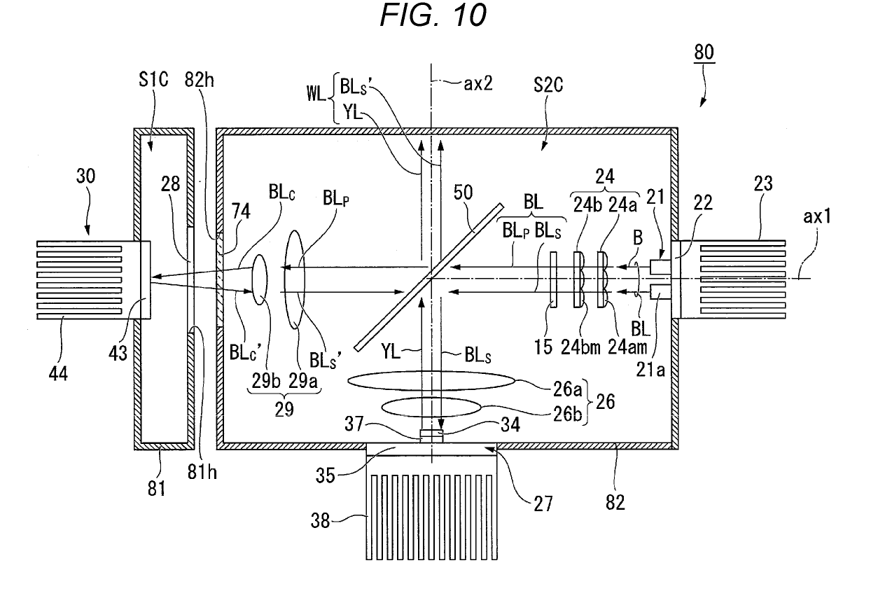

A third embodiment of the invention will hereinafter be described using FIG. 9.

A projector according to the third embodiment is roughly the same in basic configuration as that of the first embodiment, but is different in the configuration of the light source device from that of the first embodiment. Therefore, the description of the projector will be omitted, and only the light source device will be described.

FIG. 9 is a schematic configuration diagram of the light source device 76 according to the third embodiment.

In FIG. 9, the constituents common to FIG. 8 used in the description of the second embodiment are denoted by the same reference symbols, and the detailed description thereof will be omitted.

As shown in FIG. 9, the light source device 76 according to the present embodiment is provided with a first fixation member 75, the first window member 72, the second fixation member 73, the second window member 74, the light source 21, the homogenizer optical system 24, the first wave plate 15, the polarization separation element 50, the first light collection optical system 26, the wavelength conversion section 27, the second wave plate 28, a second light collection optical system 77 (an optical element), a lens holder 78 (a holding member) and the diffusion section 30. The second fixation member 73 is formed of a separate member from the first fixation member 75.

In the first fixation member 75, in the first space S1B, there are housed the second wave plate 28, the second light collection optical system 77, the lens holder 78 and the diffusion section 30. Further, the first fixation member 75 fixes the second wave plate 28, the second light collection optical system 77, the lens holder 78 and the diffusion section 30 inside the first space S1B. Further, similarly to the second embodiment, the first fixation member 75 has an opening 75h which the light proceeding from the polarization separation element 50 toward the diffusion section 30, and the light diffusely reflected by the diffusion section 30 pass through. The opening 75h is closed by the first window member 72.

The lens holder 78 holds a first pickup lens 77a and a second pickup lens 77b constituting the second light collection optical system 77. The light reflecting side of the diffusion section 30 is covered with the second light collection optical system 77 and the lens holder 78.

The rest of the configuration is substantially the same as that of the second embodiment.

Also in the light source device 76 according to the present embodiment, since the diffusion section 30 is connected to the first fixation member 75 so as to be able to conduct heat to each other, it is possible to obtain substantially the same advantage as that of the first embodiment, namely the advantage that the heat generated in the diffusion section 30 is efficiently conducted to the first fixation member 75, and thus, the reliability of the diffusion section 30 can be ensured.

Further, in the present embodiment, since the pickup lenses 77a, 77b constituting the second light collection optical system 77 are held by the lens holder 78, the light emitted with a large divergence angle out of the light diffusely reflected by the diffusion section 30 is blocked by the lens holder 78. Therefore, it is possible to prevent generation of stray light inside the first space S1B.

### Fourth Embodiment

A fourth embodiment of the invention will hereinafter be described using FIG. 10.

A projector according to the fourth embodiment is roughly the same in basic configuration as that of the first embodiment, but is different in the configuration of the light source device from that of the first embodiment. Therefore, the description of the projector will be omitted, and only the light source device will be described.

FIG. 10 is a schematic configuration diagram of the light source device 80 according to the fourth embodiment.

In FIG. 10, the constituents common to the drawings used in the first embodiment are denoted by the same reference symbols, and the detailed description thereof will be omitted.

As shown in FIG. 10, the light source device 80 according to the present embodiment is provided with a first fixation member 81, a second fixation member 82, the second window member 74, the light source 21, the homogenizer optical system 24, the first wave plate 15, the polarization separation element 50, the first light collection optical system 26, the wavelength conversion section 27, the second wave plate 28 (the retardation element), the second light collection optical system 29 (the optical element), and the diffusion section 30. The second fixation member 82 is formed of a separate member from the first fixation member 81.

The first fixation member 81 is a box-like member formed of metal high in thermal conductivity such as copper or aluminum, and has a first space S1C surrounded by a plurality of plate parts. In the first spate S1C, there is housed the diffusion section 30. Further, the first fixation member 81 fixes the diffusion section 30 inside the first space S1C.

The first fixation member 81 has an opening 81h which the light proceeding from the polarization separation element 50 toward the diffusion section 30, and the light diffusely reflected by the diffusion section 30 pass through. The opening 81h is closed by the second wave plate 28. According to this configuration, the first space S1C becomes a closed space, and there is no chance for dust or the like to enter the first space S1C.

Further, the second fixation member 82 is a box-like member formed of metal high in thermal conductivity such as copper or aluminum, and has a second space S2C surrounded by a plurality of plate parts. In the second space S2C, there are housed the light source 21, the homogenizer optical system 24, the first wave plate 15, the polarization separation element 50, the first light collection optical system 26, the wavelength conversion section 27 and the second light collection optical system 29. Further, the second fixation member 82 fixes the light source 21, the homogenizer optical system 24, the first wave plate 15, the polarization separation element 50, the first light collection optical system 26, the wavelength conversion section 27 and the second light collection optical system 29 inside the second space S2C.

The second fixation member 82 has an opening 82h which the light proceeding from the polarization separation element 50 toward the diffusion section 30, and the light diffusely reflected by the diffusion section 30 pass through. The opening 82h is closed by the second window member 74.

The rest of the configuration is substantially the same as that of the first embodiment.

Also in the light source device 80 according to the present embodiment, since the diffusion section 30 is connected to the first fixation member 81 so as to be able to conduct heat to each other, it is possible to obtain substantially the same advantage as that of the first embodiment, namely the advantage that the heat generated in the diffusion section 30 is efficiently conducted to the first fixation member 81, and thus, the reliability of the diffusion section 30 can be ensured.

Further, in the present embodiment, since the opening 81h of the first fixation member 81 is closed by the second wave plate 28, it is unnecessary to separately prepare a window member for closing the opening 81h, and it is possible to achieve reduction of the number of components of the light source device 80.

### Fifth Embodiment

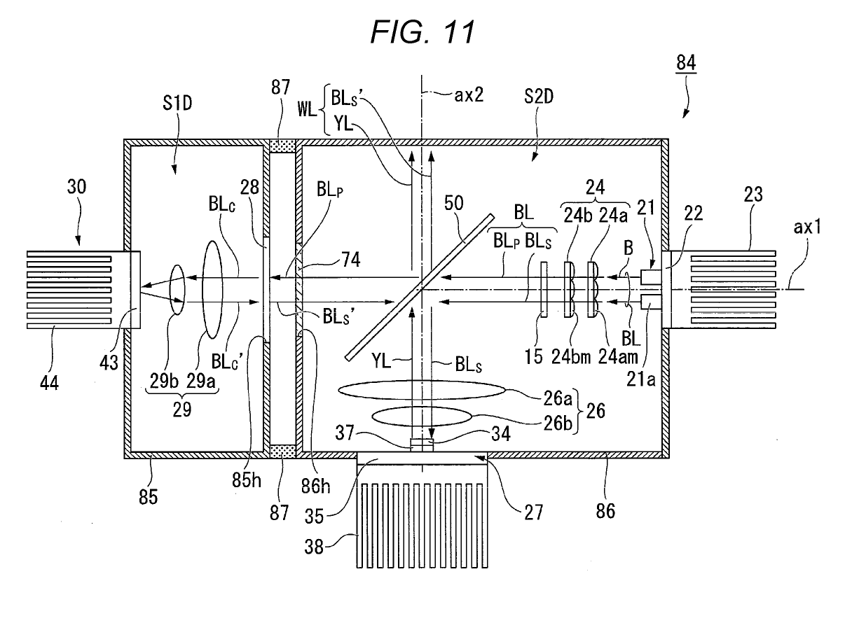

A fifth embodiment of the invention will hereinafter be described using FIG. 11.

A projector according to the fifth embodiment is roughly the same in basic configuration as that of the first embodiment, but is different in the configuration of the light source device from that of the first embodiment. Therefore, the description of the projector will be omitted, and only the light source device will be described.

FIG. 11 is a schematic configuration diagram of the light source device 84 according to the fifth embodiment.

In FIG. 11, the constituents common to the drawings used in the first embodiment are denoted by the same reference symbols, and the detailed description thereof will be omitted.

As shown in FIG. 11, the light source device 84 according to the present embodiment is provided with a first fixation member 85, a second fixation member 86, the second window member 74, the light source 21, the homogenizer optical system 24, the first wave plate 15, the polarization separation element 50, the first light collection optical system 26, the wavelength conversion section 27, the second wave plate 28 (the retardation element), the second light collection optical system 29 (the optical element), the diffusion section 30 and a thermal insulation material 87. The second fixation member 86 is configured as a separate member from the first fixation member 85.

The first fixation member 85 is a box-like member formed of metal high in thermal conductivity such as copper or aluminum, and has a first space S1D surrounded by a plurality of plate parts. In the first space S1D, there are housed the second light collection optical system 29 and the diffusion section 30. Further, the first fixation member 85 fixes the second light collection optical system 29 and the diffusion section 30 inside the first space S1D.

The first fixation member 85 has an opening 85h which the light proceeding from the polarization separation element 50 toward the diffusion section 30, and the light diffusely reflected by the diffusion section 30 pass through. The opening 85h is closed by the second wave plate 28.

The second fixation member 86 is a box-like member formed of metal high in thermal conductivity such as copper or aluminum, and has a second space S2D surrounded by a plurality of plate parts. In the second space S2D, there are housed the light source 21, the homogenizer optical system 24, the first wave plate 15, the polarization separation element 50, the first light collection optical system 26 and the wavelength conversion section 27. Further, the second fixation member 86 fixes the light source 21, the homogenizer optical system 24, the first wave plate 15, the polarization separation element 50, the first light collection optical system 26 and the wavelength conversion section 27 inside the second space S2D.

The second fixation member 86 has an opening 86h which the light proceeding from the polarization separation element 50 toward the diffusion section 30, and the light diffusely reflected by the diffusion section 30 pass through. The opening 86h is closed by the second window member 74.

The second fixation member 86 is connected to the first fixation member 85 via the thermal insulation material 87. As the thermal insulation material 87, there is used a thermal insulation material used for typical optical equipment, and the type of the thermal insulation material is not particularly limited.

The rest of the configuration is substantially the same as that of the first embodiment.

Also in the light source device 84 according to the present embodiment, since the diffusion section 30 is connected to the first fixation member 85 so as to be able to conduct heat to each other, it is possible to obtain substantially the same advantage as that of the first embodiment, namely the advantage that the heat generated in the diffusion section 30 is efficiently conducted to the first fixation member 85, and thus, the reliability of the diffusion section 30 can be ensured.

In particular, in the present embodiment, since the second fixation member 86 is connected to the first fixation member 85 via the thermal insulation material 87, when the heat generated from the wavelength conversion section 27 and the light source 21 is transferred to the second fixation member 86, it is difficult for the heat to affect the diffusion section 30, and thus the reliability of the diffusion section 30 can be ensured. Further, it is easy to treat the first fixation member 85 and the second fixation member 86 in a lump.

### Practical Example

The inventors verify whether or not the speckle noise has successfully been reduced without using a measure of rotating the diffusion plate in the light source device according to the first embodiment with a simulation. The result of the simulation will hereinafter be described.

In the projector, assuming that the numerical aperture on the projection side when the light from the projection optical system enters the screen SCR is NAp, and the numerical aperture on the observation side when the light is emitted from the screen SCR is NAe as shown in FIG. 13, the speckle contrast SC is expressed as Formula (1) described below.

$$S C = \frac{1}{\sqrt{K}} = \frac{{NA}_{e}}{{NA}_{p}} \qquad ( 1 )$$

As is obvious from Formula (1), in the case in which the observation side numerical aperture NAe is constant, the speckle contrast is determined by the projection side numerical aperture NAp. In the projector, the projection side numerical aperture NAp can be obtained from the distance between the exit pupil of the projection optical system and the screen, and the size of the exit pupil. The observation side numerical aperture NAe can be obtained from the distance between the observer and the screen, and the size of the pupil of the observer.

It should be noted that the speckle contrast SC is calculated using Formula (1) based on the premise that the illuminance distribution of the pupil image in the exit pupil of the projection optical system is even within the range of the projection side numerical aperture NAp. However, since the illuminance of the exit pupil image of the actual projector is not even, the premise of Formula (1) is not fulfilled, and it is unachievable to correctly calculate the speckle contrast SC.

Therefore, the inventors have derived by experiment a formula for obtaining an index with which the speckle noise can accurately be evaluated even if the exit pupil image has the illuminance distribution (see, e.g., JP-A-2015-64444).

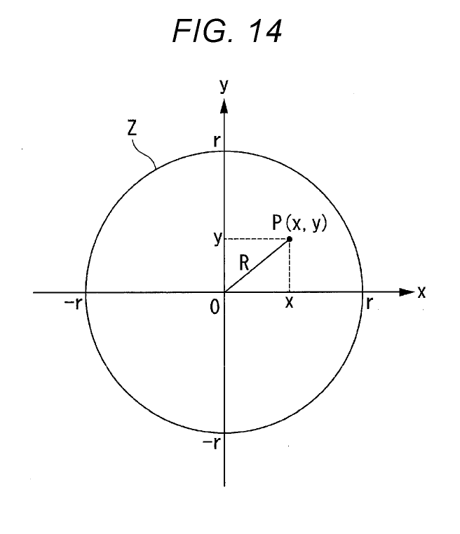

As shown in FIG. 14, the axes perpendicular to each other taking the center of the exit pupil image Z as the origin O of the coordinate are defined as an x axis and a y axis. In this case, defining the normalized illuminance of a point in the coordinate (x,y) as P(x,y), the index expressed by Formula (2) described below is referred to as an EP (effective pupil) value.

EP=∫₋ᵣ^{r}∫₋ᵣ^{r}\sqrt{x²+y²}P(x,y)dxdy (2)

It should be noted that the normalized illuminance P(x,y) can be obtained by Formula (3) described below.

P(x,y)=(illuminance) [cd/m²]/(average illuminance of the top 0.1% of the illuminance distribution of the exit pupil image) [cd/m²] (3)

In Formula (2), by using the normalized illuminance instead of the absolute illuminance, the EP value can be calculated irrespective of the brightness of the exit pupil image. Further, by using the average illuminance of the top 0.1% in brightness of the exit pupil image when calculating the normalized illuminance, the accuracy of the calculation result of the EP value can further be improved.

The inventors have examined the correlative relationship between the EP value and the speckle contrast when varying the illuminance distribution of the exit pupil image with respect to the blue light having the wavelength of 450 nm±10 nm.

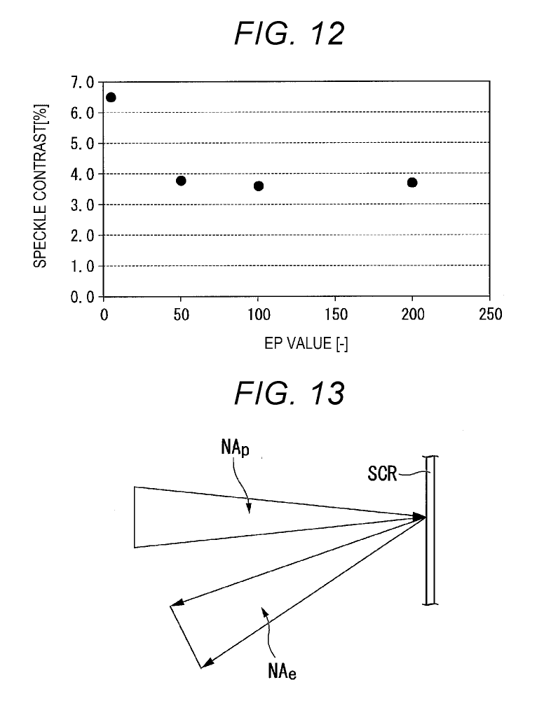

FIG. 12 is a graph showing the relationship between the EP value and the speckle contrast. In FIG. 12, the horizontal axis represents the EP value [−], and the vertical axis represents the speckle contrast [%].

As shown in FIG. 12, it has been figured out that the speckle contrast has become roughly constant in a level lower than 4% when making the EP value equal to or greater than 50. From the result of the sensory evaluation and so on, the inventors have obtained the findings that the observer has not recognized the speckle noise if the speckle contrast is lower than 4% with respect to the blue light. Therefore, it has been confirmed that by making the EP value equal to or greater than 50, the observer has not recognized the speckle noise without using the measure of rotating the diffusion plate in the light source device. Although not presented here, it has been found out that by making the EP value equal to or greater than a predetermined value, the speckle contrast can be made roughly constant with respect also to the green light and the red light.

It should be noted that the scope of the invention is not limited to the embodiments described above, but a variety of modifications can be provided thereto within the scope or the spirit of the invention.

For example, although in the embodiments described above there is illustrated the configuration in which the wavelength conversion section is fixed to the fixation member in addition to the diffusion section, the configuration of the wavelength conversion section is not limited to the example described above, but it is also possible for the wavelength conversion section to have a configuration in which a substrate provided with a phosphor layer is rotated by a motor.

Besides the above, the numbers, the shapes, the materials, the arrangement, and so on of the constituents constituting the light source device can arbitrarily be modified. Further, although in the embodiments described above, there is illustrated the projector provided with the three light modulation devices, the invention can also be applied to a projector for displaying a color picture using a single light modulation device. Further, the light modulation device is not limited to the liquid crystal panel described above, but a digital mirror device, for example, can also be used.

Besides the above, the shapes, the numbers, the arrangement, the materials, and so on of the variety of constituents of the projector are not limited to those of the embodiments described above, but can arbitrarily be modified.

Further, although in the embodiments described above, there is described the example of installing the light source device according to the invention in the projector, this is not a limitation. The light source device according to the invention can also be applied to lighting equipment, a headlight of a vehicle, and so on.

The entire disclosure of Japanese Patent Application No. 2018-043849, filed Mar. 12, 2018 is expressly incorporated by reference herein.

What is claimed is:

1. A light source device comprising:
a light source adapted to emit light;
a diffuser adapted to diffusely refract the light emitted from the light source;
an optical element adapted to guide the light to the diffuser; and
a first fixation member having a first space, the first fixation member adapted to fix the diffuser inside the first space,
wherein the diffuser is connected to the first fixation member so as to conduct heat to each other.

2. The light source device according to claim 1, wherein:
the diffuser includes a diffusion element and a radiation member connected to the diffusion element to radiate heat from the diffusion element, and
at least a part of the radiation member is disposed outside the first fixation member.

3. The light source device according to claim 1, further comprising:
a wavelength converter adapted to convert wavelength of the light emitted from the light source,
wherein the first fixation member fixes the light source and the wavelength converter inside the first space.

4. The light source device according to claim 1, further comprising:
a wavelength converter adapted to convert wavelength of the light emitted from the light source; and
a second fixation member having a second space, the second fixation member adapted to fix the light source and the wavelength converter inside the second space,
wherein the second fixation member is a separate body from the first fixation member.

5. The light source device according to claim 4, wherein
the second fixation member is connected to the first fixation member via a thermal insulation material.

6. The light source device according to claim 1, further comprising:
a holding member adapted to hold the optical element,
wherein a light reflecting side of the diffuser is covered with both the optical element and the holding member.

7. The light source device according to claim 1, further comprising:
a retardation element adapted to convert a polarization state of light,
wherein:
the first fixation member has an opening through which light proceeding toward the diffuser and light diffusely reflected by the diffuser pass, and
the opening is closed by the retardation element.

8. A projector comprising:
the light source device according to claim 1;
a light modulation device adapted to modulate the light from the light source device in accordance with image information; and
a projection optical device adapted to project the light modulated by the light modulation device.

9. A projector comprising:
the light source device according to claim 2;
a light modulation device adapted to modulate the light from the light source device in accordance with image information; and
a projection optical device adapted to project the light modulated by the light modulation device.

10. A projector comprising:
the light source device according to claim 3;
a light modulation device adapted to modulate the light from the light source device in accordance with image information; and
a projection optical device adapted to project the light modulated by the light modulation device.

11. A projector comprising:
the light source device according to claim 4;
a light modulation device adapted to modulate the light from the light source device in accordance with image information; and
a projection optical device adapted to project the light modulated by the light modulation device.

12. A projector comprising:
the light source device according to claim 5;
a light modulation device adapted to modulate the light from the light source device in accordance with image information; and
a projection optical device adapted to project the light modulated by the light modulation device.

13. A projector comprising:
the light source device according to claim 6;
a light modulation device adapted to modulate the light from the light source device in accordance with image information; and
a projection optical device adapted to project the light modulated by the light modulation device.

14. A projector comprising:
the light source device according to claim 7;
a light modulation device adapted to modulate the light from the light source device in accordance with image information; and
a projection optical device adapted to project the light modulated by the light modulation device.
